(19) United States
(12) Patent Application Publication
(10) Pub. No.: US 2006/0291644 A1
(43) Pub. Date: Dec. 28, 2006

(54) Method and apparatus for managing scripts across service centers according to business conditions

(75) Inventors: Matthew Ellinwood, San Ramon, CA (US); Saikat Mitra, Fremont, CA (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/151,943

(22) Filed: Jun. 14, 2005

(51) Int. Cl. H04M 3/00

(52) U.S. Cl. 379/265.02

(57) ABSTRACT

A script generator (101) coupled to one or more service centers (112) has a memory (106), and a processor (104). The processor is programmed to establish (202)a library of scripts for use by the service centers to process calls from calling parties, receive (204) one or more business criterions according to business conditions of the enterprise, and adjust (210) the accessibility of scripts at each of the service centers according to the one or more business criterions.

### FIELD OF THE INVENTION

This invention relates generally to survey methods, and more particularly to a method and apparatus for managing scripts across service centers according to business conditions.

### BACKGROUND OF THE INVENTION

Communication scripts are generally used by operators at service centers to respond to calling parties in a consistent and reliable manner. Scripts, however, tend to be static by design with minimal capability for adjustment to business conditions as they arise. When high call traffic conditions are present, for example, static scripts can result in a low throughput of call processing at each of the service centers, which in turn can lead to frustration for those customers who cannot access a service agent within a reasonable time.

### SUMMARY OF THE INVENTION

Embodiments in accordance with the invention provide a method and apparatus for managing scripts across service centers according to business conditions.

In a first embodiment of the present invention, a computer-readable storage medium is coupled to one or more service centers of an enterprise. The storage medium has computer instructions for establishing a library of scripts for use by the service centers to process calls from calling parties, receiving one or more business criterions according to business conditions of the enterprise, and adjusting the accessibility of scripts at each of the service centers according to the one or more business criterions.

In a second embodiment of the present invention, a script generator coupled to one or more service centers has a memory, and a processor. The processor is programmed to establish a library of scripts for use by the service centers to process calls from calling parties, receive one or more business criterions according to business conditions of the enterprise, and adjust the accessibility of scripts at each of the service centers according to the one or more business criterions.

In a third embodiment of the present invention, a method operates in one or more service centers of an enterprise. The method has the steps of establishing a library of scripts for use by the service centers to process calls from calling parties, receiving one or more business criterions according to business conditions of the enterprise, and adjusting the accessibility of scripts at each of the service centers according to the one or more business criterions.

### BRIEF DESCRIPTION OF THE DRAWINGS

FIG. 1 is block diagram of a script generator coupled to one or more service centers by way of a communication network according to an embodiment of the present invention; and

FIG. 2 depicts a flow chart of a method operating in the script generator according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

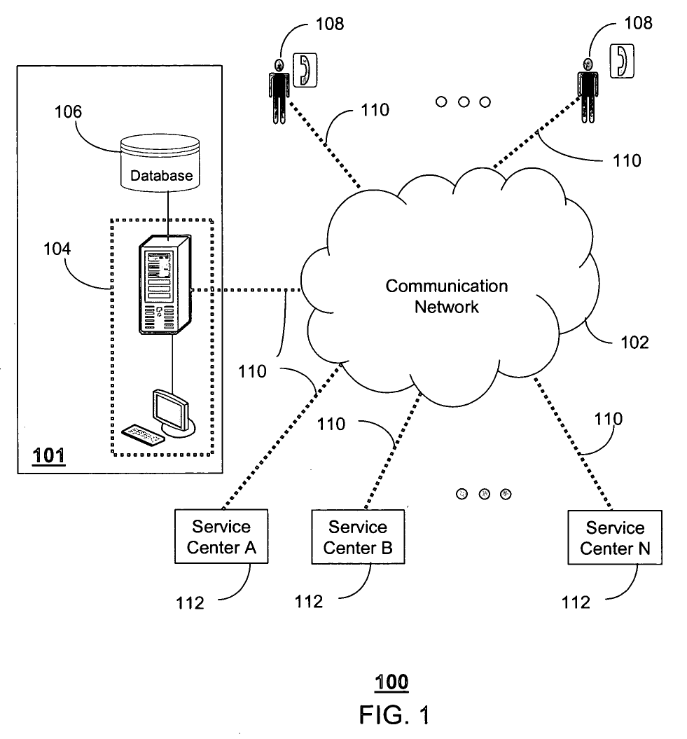

FIG. 1 is block diagram 100 of a script generator 101 coupled to one or more service centers 112 by way of a communication network 102 according to an embodiment of the present invention. The script generator 101 utilizes conventional technology such as a processor 104 and a memory 106. The processor 104 can be represented by a conventional computer or server coupled to a conventional display terminal. The memory 106 utilizes a conventional media device (such as a high capacity disk drive) for storage purposes and can be used in the present application as a database for managing scripts used by operators of the service centers 112. Although the processor 104 and memory 106 are shown separately, they can be in the alternative an integral unit.

The script generator 101 is coupled to a conventional communication network 102 such as a PSTN (Public Switched Telephone Network), IP (Internet Protocol) network, and/or a wireless communication network. One or more calling parties 108 can communicate with an operator of a service center 112 by way of the communication network 102. The operators of each service center 112 are supplied one or more communication scripts (herein “scripts”) from the script generator 101 to process calls from the calling parties 108. The service centers 112 together form an enterprise. The enterprise can be in the business of providing Internet services, cellular phone services, and/or local and long-distance communication services. The operators of the service centers 112 can, for example, assist customers with installation of new services, billing inquiries, and technical support, among other functions.

It would be obvious to an artisan with ordinary skill in the art that the present invention can be applied to any business enterprise which employs service centers 112 to serve the needs of new and existing customers.

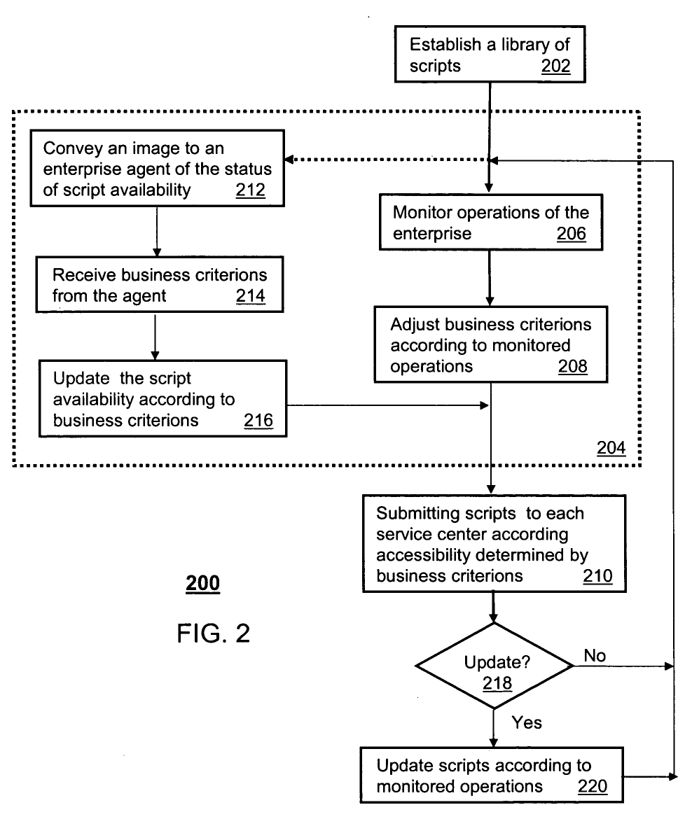

FIG. 2 depicts a flow chart of a method 200 operating in the script generator 101 according to an embodiment of the present invention. Method 200 begins with step 202 where the script generator 101 establishes a library of scripts, which are stored in the memory 106. This step can take on any number of embodiments. For example, communication scripts in the library can be defined hierarchically by an enterprise agent by service center, sub-groups of operators in a service center, country region, demographic segmentation, psychographic segmentation, or other useful means for directing operators of the service centers to serve the needs of the calling parties 108. Scripts can be periodically updated by service personnel of the enterprise according to a change in business conditions, or autonomously by the script generator 101 as will be discussed shortly.

In order to manage operator access to the scripts, in one embodiment each script includes one or more accessibility flags. Any number of accessibility flags can be used to manage access to the scripts. For instance, accessibility flags can be associated by operator, in which case access to scripts can be defined for each operator of a service center 112. Alternatively or in combination, accessibility flags can be defined by service center so as to vary accessibility by service center. In addition, accessibility flags can be defined by product line in which case accessibility to the scripts can be controlled according to specific product lines. It should be evident to an artisan with ordinary skill in the art from the foregoing examples that any association can be applied to the scripts to vary their access to the operators of the service centers 112.

Referring back to method 200, in step 204, the script generator receives one or more business criterions according to business conditions of the enterprise. Business criterions can be represented by operational metrics of the enterprise such as, for example, the operational efficiency of each service center, market segmentation of calling parties of each service center, operational efficiency of the enterprise in whole or in part, profitability of each service center, profitability of the enterprise, customer satisfaction rating at each service center, and/or customer satisfaction rating for the enterprise.

FIG. 2 illustrates a number of embodiments which can be applied to step 204. It would be evident to those of ordinary skill in the art that any method for generating business criterions which improves the efficacy of the enterprise is suitable for the present invention. With this in mind, in a first embodiment of step 204, the script generator 101 begins by monitoring operations of the enterprise in step 206. The script generator 101 can be programmed in this step to monitor any useful operating metric of the enterprise such as, for instance, the number of calls received, throughput of calls processed, frequency of closed sales by product offering, customer satisfaction surveys, profitability by operator, profitability by service center, profitability by product line, profitability by enterprise division, and so on. Additionally, the metrics measured can be synthesized according to any category such as, for example, by service center, by groups of operators within a service center, by individual operators, or any portion or combination thereof that proves to be useful in managing enterprise operations.

In step 208, the script generator 101 can be programmed to adjust the aforementioned business criterions according to the operations monitored in step 206. This step can therefore represent an adjustment of previously established business criterions or newly formed business criterions adjusted according to the results of step 206. For instance, assume that prior to step 206, a service center 112 for processing billing inquiries was receiving a number of scripts from the script generator 101 requesting that each operator of said center request contact information from the calling party such as name, address, phone number and email address if available. Further assume that the script generator 101 in step 206 determines that the service center 11 2 is receiving excessive calls which are resulting in caller hold times that exceed what is known to be the average tolerance of said callers. The script generator 101 can be programmed in step 208 to adjust the business criterions that affect the accessibility of the scripts to mitigate this condition.

In particular, the business criterions can be adjusted so that the communication scripts submitted to the operators in step 210 are reduced to essentials (e.g., name of customer). Consequently, the operators of the service center 112 can address calls faster, and thereby reduce hold times for the calling parties 108. Steps 206 and 208 can thus be performed dynamically without human intervention.

In an alternative embodiment of step 204, the script generator 101 can be operated directly by agents of the enterprises. The responsibility and authority of the agents of the enterprise to manipulate the operation of the script generator 101 can vary. For instance, some agents may be responsible for individual operators of a service center 112 or sub-groups thereof. Other agents may be given responsibility and control over a number of service centers 112. In yet another embodiment, agents can be subdivided by product offering. In this embodiment, several agents may control scripts over several service centers 112 according to their respective product responsibility.

In step 212, the script generator 101 conveys an image at a display terminal which can indicate to an agent a status of active and inactive scripts determined according to the associated accessibility flags of each script. The script status provided to the agent can be limited by the agent's scope of responsibility. In other words, the agent only sees scripts s/he is responsible for. The image conveyed can be graphical, textual, or combinations thereof. Assume for illustration purposes that the agent is responsible for a particular service center. The agent in this instance may be familiar with operating conditions of the service center from personal interactions with the operators, or by way of tools available to the agent for monitoring the centers operations. In the latter case, said tools can be supplied by the script generator 101 through step 206, in which case, the image conveyed to the agent also describes relevant operating conditions of the service center.

In step 214, the script generator 101 receives business criterions from the agent. The business criterions can be reflected by, for example, editing steps performed by the agent on preexisting script states. That is, the agent can be presented in step 212 a graphical matrix of all the scripts and their respective state of operation. From this display, the agent can, for example, rearrange the matrix according to a change in operating conditions at the service center 212. The editing steps can be as simple as presenting the agent each script with an associated graphic on or off button which can be toggled by the agent at will, thereby updating the accessibility flag of said script in step 216. In a more sophisticated embodiment, the agent can track operational metrics of the enterprise as described in step 206, create business rules that synthesize the metrics monitored, and thereby generate business criterions in step 214, which in turn update the accessibility flags of each script in step 216.

From the aforementioned embodiments of step 204 (and derivatives thereof), the script generator 101 proceeds to step 210 where it submits scripts to each service center according to accessibility determined by the business criterions supplied thereto. In a supplemental embodiment, the script generator 101 can be further programmed to determine in step 218 when it may be appropriate to update in step 220 scripts established in step 202 according to the operating conditions monitored. These steps provide a means to dynamically update the scripts as operational conditions may warrant. Any conventional method known for dynamically updating communication scripts according to operating metrics can be used. For example, periodic survey sampling of calling parties 108 with an Interactive Voice Response (IVR) system can serves as a source for directing restructuring and/or modifications of existing scripts.

It should be evident by now that the present invention can be realized in hardware, software, or a combination of hardware and software. Moreover, the present invention can be realized in a centralized fashion, or in a distributed fashion where different elements are spread across several interconnected processors. For instance, the script generator 101 can be a server that controls conventional monitors serving as slave devices used by the operators to read scripts. Alternatively, the operators can use conventional desktop computers which store scripts locally, and wherein access to said scripts is controlled remotely by the script generator 101. Thus, any kind of computing device or other apparatus adapted for carrying out method 200 described above is suitable for the present invention.

It should be also evident that the present invention may be used for many applications. Thus, although the description is made for particular arrangements and methods, the intent and concept of the invention is suitable and applicable to other arrangements and applications not described herein. It would be clear therefore to those skilled in the art that modifications to the disclosed embodiments described herein could be effected without departing from the spirit and scope of the invention.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein. A software program in the present context means any expression, in any language, code or notation, of a set of instructions intended to cause a system having an information processing capability to perform a particular function either directly or after either or both of the following: a) conversion to another language, code or notation; b) reproduction in a different material form.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, other re-writable (volatile) memories or Signals containing instructions. A digital file attachment to e-mail or other self-contained information archive or set of archives sent through signals is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. A computer-readable storage medium coupled to one or more service centers of an enterprise, the storage medium comprising computer instructions for:
establishing a library of scripts for use by the service centers to process calls from calling parties;
receiving one or more business criterions according to business conditions of the enterprise; and
adjusting the accessibility of scripts at each of the service centers according to the one or more business criterions.

2. The storage medium of claim 1, wherein the business criterions are received from an agent of the enterprise.

3. The storage medium of claim 1, comprising computer instructions for:
monitoring operations of a portion the enterprise; and
adjusting the business criterions according to the operations monitored.

4. The storage medium of claim 1, wherein business criterions are among at least one of a group of criterions comprising operational efficiency of each service center, market segmentation of calling parties of each service center, operational efficiency of the enterprise, profitability of each service center, profitability of the enterprise, customer satisfaction rating at each service center, and customer satisfaction rating for the enterprise.

5. The storage medium of claim 3, comprising computer instructions for:
submitting a portion of the scripts to each service center according to the adjusted business criterions; and
when applicable, updating the scripts according to operations monitored.

6. The storage medium of claim 1, wherein each script includes one or more accessibility flags corresponding to each service center, and wherein the storage medium comprises computer instructions for updating the accessibility flags according to the business criterions.

7. The storage medium of claim 6, comprises computer instructions for:
conveying an image to an agent of the enterprise indicating a status of each accessibility flag of the scripts;
receiving from the agent one or more business criterions;
updating the one or more accessibility flags according to the one or more business criterions supplied by the agent; and
submitting a portion of the scripts to each service center according to the updated accessibility flags.

8. The storage medium of claim 1, comprising computer instructions for submitting a portion of the scripts to each service center according to accessibility determined by the business criterions.

9. A script generator coupled to one or more service centers, comprising:
a memory; and
a processor, wherein the processor is programmed to:
establish a library of scripts for use by the service centers to process calls from calling parties;
receive one or more business criterions according to business conditions of the enterprise; and
adjust the accessibility of scripts at each of the service centers according to the one or more business criterions.

10. The script generator of claim 9, wherein the business criterions are received from an agent of the enterprise.

11. The script generator of claim 9, wherein the processor is programmed to:
monitor operations of a portion the enterprise; and
adjust the business criterions according to the operations monitored.

12. The script generator of claim 9, wherein business criterions are among at least one of a group of criterions comprising operational efficiency of each service center, market segmentation of calling parties of each service center, operational efficiency of the enterprise, profitability of each service center, profitability of the enterprise, customer satisfaction rating at each service center, and customer satisfaction rating for the enterprise.

13. The script generator of claim 1 1, wherein the processor is programmed to:
submit a portion of the scripts to each service center according to the adjusted business criterions; and
when applicable, update the scripts according to operations monitored.

14. The script generator of claim 9, wherein each script includes an accessibility flag corresponding to each service center, and wherein the processor is programmed to update the accessibility flag according to the business criterions.

15. The script generator of claim 14, wherein the processor is programmed to:
convey an image to an agent of the enterprise indicating a status of each accessibility flag of the scripts;
receive from the agent one or more business criterions;
update the one or more accessibility flags according to the one or more business criterions supplied by the agent; and
submit a portion of the scripts to each service center according to the updated accessibility flags.

16. The script generator of claim 9, wherein the processor is programmed to submit a portion of the scripts to each service center according to accessibility determined by the business criterions.

17. In one or more service centers of an enterprise, a method comprising the steps of:
establishing a library of scripts for use by the service centers to process calls from calling parties;
receiving one or more business criterions according to business conditions of the enterprise; and
adjusting the accessibility of scripts at each of the service centers according to the one or more business criterions.

18. The method of claim 17, comprising the steps of:
monitoring operations of a portion the enterprise;
adjusting the business criterions according to the operations monitored;
submitting a portion of the scripts to each service center according to the adjusted business criterions; and
when applicable, updating the scripts according to operations monitored.

19. The method of claim 17, wherein business criterions are among at least one of a group of criterions comprising operational efficiency of each service center, market segmentation of calling parties of each service center, operational efficiency of the enterprise, profitability of each service center, profitability of the enterprise, customer satisfaction rating at each service center, and customer satisfaction rating for the enterprise.

20. The method of claim 1, wherein each script includes an accessibility flag corresponding to each service center, and wherein the method comprises the steps of:
conveying an image to an agent of the enterprise indicating a status of each accessibility flag of the scripts;
receiving from the agent one or more business criterions;
updating the one or more accessibility flags according to the one or more business criterions supplied by the agent; and
submitting a portion of the scripts to each service center according to the updated accessibility flags.
